(19) United States
(12) Patent Application Publication
(10) Pub. No.: US 2011/0159396 A1
(43) Pub. Date: Jun. 30, 2011

(54) BIPOLAR PLATE FOR A FUEL CELL ARRANGEMENT, IN PARTICULAR FOR PLACEMENT BETWEEN TWO ADJACENT MEMBRANE ELECTRODE ARRANGEMENTS

(75) Inventors: Joerg Kleemann, Ulm (DE); Markus Schudy, Heppenheim (DE); Felix Blank, Konstanz (DE); Florian Finsterwalder, Illerkirchberg (DE)

(73) Assignee: DAIMLER AG, Stuttgart (DE)

(21) Appl. No.: 13/054,117

(22) PCT Filed: Jul. 9, 2009
(86) PCT No.: PCT/EP09/04985

§ 371 Date: Mar. 16, 2011

(30) Foreign Application Priority Data
Jul. 15, 2008 (DE) 10 2008 033 211.9

(51) Int. Cl. H01M 8/24; H01M 8/04

(52) U.S. Cl. 429/457; 429/512

(57) ABSTRACT

The invention relates to a bipolar plate (3) for a fuel cell arrangement (1), in particular for placement between two adjacent membrane electrode arrangements, comprising at least one or two plates disposed plane-parallel relative to one another, wherein a flow field (F) is formed from the channel structures made in the respective plate at least on one or both outer sides, respectively, said channel structures comprising a plurality of channels (K) running between a fluid inlet (E) and a fluid outlet (A) and webs (S) running between two channels (K). According to the invention, the channels (K) and/or the webs (S) comprise at least one varying channel width (b1), one varying web width (b2) and/or one varying channel distance (a) on at least one of the outer sides along a flow direction (R) of a fluid between the fluid inlet (E) and the fluid outlet (A).

The invention relates to a bipolar plate for a fuel cell arrangement, particularly for placement between two adjacent membrane electrode arrangements in a fuel cell stack according to the characteristics of the preamble of claim 1 and a fuel cell arrangement according to the characteristics of the preamble of claim 11.

A fuel cell arrangement or a fuel cell stack (also called stack in short) consists of several fuel cells arranged electrically in series, stacked above each other in a plane-parallel manner. Each fuel cell has an anode, a cathode and an electrolyte arranged therebetween, for example in the form of a polymer electrolyte membrane (called PEM in short) as electrodes in the form of gas diffusion electrodes, which together form a membrane electrode arrangement (called MEA in short).

A bipolar plate (also called bipolar separator plate) is respectively arranged between the adjacent membrane electrode arrangements in the fuel cell stack. The bipolar plate thereby serves for the spacing of adjacent membrane electrode arrangements, the distributing of reaction materials for the fuel cell such as fuel and oxidant over the abutting membrane electrode arrangements and the discharging of the reaction materials in channels provided for this, respectively open towards the membrane electrode arrangements, the discharge of the reaction heat via a coolant guided in separate coolant channels and the production of an electrical connection between the anode and the cathode of adjacent membrane electrode arrangements.

A fuel and an oxidant are used as reaction materials. Gaseous reaction materials (in short: reaction gases) are often used as fuel, e.g. hydrogen or a gas containing hydrogen (e.g. reformate gas), and oxygen or a gas containing oxygen (e.g. air) as oxidant. Reaction materials are all materials taking part in the electrochemical reaction, including the reaction products, as e.g. water or depleted fuel.

The respective bipolar plate thereby consists of a formed part, preferably however of two or several formed parts connected to each other in a plane-parallel manner, in particular plates—an anode plate for the connection with the anode of the one membrane electrode arrangement and a cathode plate for the connection with the cathode of the other membrane electrode arrangement—or a plate with channel structures introduced on the upper and lower side. At the surface of the anode plate facing the one membrane electrode arrangement are thereby arranged anode channels for distributing a fuel along the one membrane electrode arrangement, wherein at the surface of the cathode plate facing the other membrane electrode arrangement are arranged cathode channels for distributing the oxidant over the other membrane electrode arrangement. The cathode channels and the anode channels have no connection to each other.

The cathode and the anode channels are thereby formed on the surfaces of the anode and cathode plate respectively facing the membrane electrode arrangements by elevations (called webs in the following) separated from each other by recesses (called channels in the following). The cathode and anode plate are preferably formed, in particular embossed. The webs and the channels are preferably produced discontinuously by embossing (with mold and die), hydroforming (with mold and fluid), high speed forming (with mold and die), stretch forming, deep-drawing, extruding, or the like, or continuously by rolling or drawing.

In order to achieve a sufficient operating efficiency and low costs with a use of a fuel cell arrangement for a vehicle during operation, the performance per square meter cell surface and the efficiency of the fuel cell have to be increased on the one hand, in that for example performance losses due to contact and/or material resistances are reduced and material and load transport are improved. On the other hand, increasingly cost-efficient materials as e.g. electrode layers that can be rolled, are used for the gas diffusion electrodes.

From DE 102005037093 A1 is for example known a fuel cell with fluid guide channels with flow cross sections changing in opposite directions.

From DE 60212001 T2 is known a fuel cell fluid distribution plate (also called bipolar plate), which has a net of progressively finer channels on at least one surface, which have one or several branched gas supply channels with a plurality of gas diffusion channels connected thereto with a width lower than 0.2 mm.

In US 20020167109 A1 is described a conventional bipolar plate and its production, wherein the flow channels have different channel cross sectional forms.

From US 20030059662A1 is known a conventional bipolar plate, which has a flow channel proceeding in the manner of a serpentine, wherein the web between adjacent channel sections of the channel varies in its width.

For improving and adjusting a material transport, between adjacent channels, a method and a device is known from U.S. Pat. No. 6,586,128B1, where pressure differences in the respective channel can be adjusted by changing the channel progress with a constant web width.

The invention is based on the object to introduce a bipolar plate for a fuel cell, which is improved compared to the bipolar plates known from the state of the art and which enables a simple adjustment with a simultaneously reduced manufacturing method. An improved fuel cell arrangement is to be introduced further.

Regarding the bipolar plate, the object is solved according to the invention by the characteristics given in claim 1. Regarding the fuel cell arrangement, the object is solved according to the invention by the characteristics given in claim 10.

Advantageous further developments of the invention are the subject of the dependent claims.

The bipolar plate for a fuel cell arrangement, in particular for placement between two adjacent membrane electrode arrangements, comprises in a conventional manner at least one or two plates disposed plane-parallel relative to one another, wherein a flow field is formed from the channel structures made in the respective plate at least on one or both outer sides, respectively, said channel structures comprising a plurality of channels running between a fluid inlet and a fluid outlet and webs running between two channels. According to the invention, the channels and/or the webs comprise at least one varying channel width, one varying web width and/or one varying channel distance on at least one of the outer sides along a flow direction of a fluid between the fluid inlet and the fluid outlet.

The channel width, web width and/or channel distances preferably vary in dependence on local requirements regarding fluid transport, heat transport and/or load transport on at least one of the media sides and thus one side of the bipolar plate, e.g. an anode side or a cathode side.

By means of such an optimization of local web widths, channel widths and/or channel distances of the flow field along the flow direction, an adaptation to local conditions can be achieved in the abutting fuel cells and thus accompanying it an optimization of the performance density of a fuel cell arrangement. In particular with a fuel cell arrangement with flexible layers of gas diffusion electrodes, different requirements of the fluid, in particular gas transport, and also different thermal and electrical conductivity requirements can be fulfilled and achieved by a corresponding variation of one of the widths, the channel width and/or the web width and/or the channel distances.

By such a variable adjustment and adaptation of the channel structure to local conditions, flexible and cost-efficient materials can additionally be used for the gas diffusion electrodes, e.g. flexible layers, in particular those that can be rolled. A cost-optimized and robust and a packing-tight fuel cell arrangement is enabled hereby.

In a possible embodiment, the channels have an increasing channel width between the fluid inlet and the fluid outlet. An optimized material or fluid transport from and to the catalyst layer is enabled hereby.

In a further alternative or additional possible embodiment, the webs have a decreasing web width between the fluid inlet and the fluid outlet along the flow direction. An improved load and heat transport is enabled hereby.

Alternatively or additionally, the channel distance between two channels arranged adjacent to each other can increase along the flow direction. A channel distance in the sense of the invention is thereby meant to be the distance of one of the channel walls of a channel to the same channel wall of an adjacent channel. In other words: The channel width corresponds to the sum of the channel width of a channel and the web width of a web abutting this channel.

The channel structure is preferably designed in such a manner for the adaptation to a local gas composition, that the channel and/or web widths vary along the flow direction of the fluids.

Conveniently, the channel width, the web width and/or the channel distances vary along the flow direction and/or the channel width and/or the web width at the fluid inlet and/or at the fluid outlet or an arbitrary combination of these differently varying widths or distances can be provided for the adaptation of the channel structure to local gas compositions. By means of such a variation of channel widths, web widths and/or channel distances, which are adapted to local gas compositions, heat and/or load transport, in particular to local oxygen concentrations, an influence on the water management in the fuel cell is also enabled. Thus, a higher water retention in the electrolyte membrane (PEM) is enabled by means of wider webs. Small channels ate the fluid inlet enable a lower temperature difference on average between the electrolyte membrane and a cooling medium, so that an optimum water housekeeping is enabled with dry inlet fluids, in particular inlet gases. The fluid, in particular the gas humidity is increased at the fluid outlet due to resulting product water, so that smaller webs and wider channels are preferred here.

For an optimum fluid transport with wide channels and a simultaneous optimum heat and load transport with wide webs and thus for opposing parameters over the entire length of the channels and webs it is provided in a preferred embodiment of the invention that the channels are formed smaller and the webs are formed wider and the channel distances are formed smaller at the fluid inlet than at the fluid outlet. By means of such a formation of the channels and of the webs, a changing partial pressure and a changing concentration of the educts within the fuel cell due to the eduction usage (=oxygen usage at the cathode) and the product generation (=water vapor at the cathode) are considered. It is in particular considered that the oxygen concentration decreases to the fluid outlet and the losses increase by a worse fluid transport. The ratio of the fluid transport to the load transport also changes thereby, which again leads to a changed optimum of channel and web width.

An alternative embodiment of the invention provides that the channel width increases along the flow direction from fluid inlet to fluid outlet with a constant web width. This enables an optimum fluid or material transport from and to the catalyst layer.

A further alternative embodiment provides that the web width increases along the flow direction from the fluid inlet to the fluid outlet with a constant channel width, whereby an improved load and heat transport is enabled in particular with flexible layers of gas diffusion electrodes.

With another alternative embodiment it can be advantageous if the web width decreases along the flow direction from the fluid inlet to the fluid outlet with a constant channel width, in order to enable an improved load and heat transport in particular with flexible layers of gas diffusion electrodes.

For a bipolar plate with a fluid supply as homogeneous as possible that can be produced in a simple and cost-efficient manner, it is provided that all channels start from a common fluid inlet. Thereby, a gaseous reaction material or fuel, e.g. hydrogen or a gas containing hydrogen e.g. air can be supplied to the fluid inlet depending on the associated electrode. Analogously to this, all channels conveniently enter a common fluid outlet, via which water or water vapor and/or a residual combustion gas can be discharged as reaction products.

The two plates are made of metal for a construction as robust as possible and a simple placement of the channel structure. The channel structure can thereby be placed into the respective plate by stretch forming, deep-drawing, extruding, or the like, or continuously by rolling or drawing.

Regarding the fuel cell arrangement with several stacked fuel cells, which are formed as a membrane electrode arrangement with an electrolyte membrane arranged between two gas diffusion electrodes, it is provided that a bipolar plate according to the invention is respectively arranged between two fuel cells.

The bipolar plate according to the invention is preferably used in a fuel cell arrangement. The fuel cell arrangement can thereby be a number of stacked polymer electrolyte membrane fuel cells, between which a bipolar plate is respectively arranged.

Embodiments of the invention are explained in more detail by means of drawings.

It shows thereby:

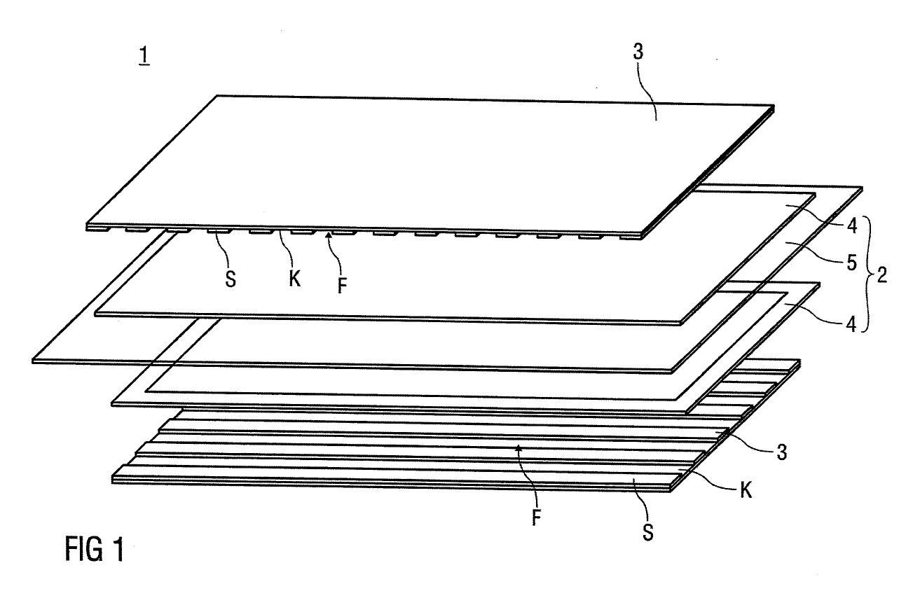

FIG. 1 schematically a typical construction of a fuel cell arrangement with an individual of several fuel cells stacked in a plane-parallel manner, which are respectively delimited at the outer side by respectively one bipolar plate,

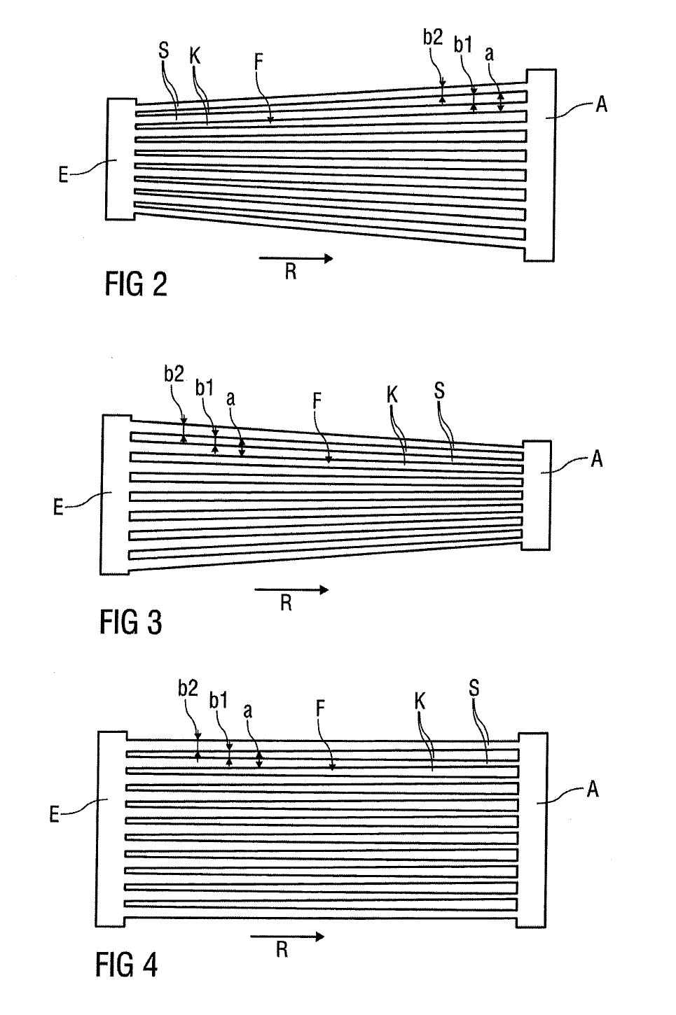

FIG. 2 schematically a possible embodiment for a channel structure on one of the outer sides of a bipolar plate with a constant web width and varying channel width,

FIG. 3 schematically a possible embodiment for a channel structure on one of the outer sides of a bipolar plate with varying web width and a constant channel width,

FIG. 4 schematically a further alternative embodiment for a channel structure on one of the outer sides of a bipolar plate with varying web width and varying channel width.

Parts corresponding to each other are provided with the same reference numerals in all figures.

FIG. 1 schematically shows a typical construction of a fuel cell arrangement 1 with an individual of several fuel cells 2 (also called membrane electrode arrangement, MEA in short) stacked in a plane-parallel manner, which are respectively delimited on the outer side by respectively one bipolar plate 3.

FIG. 1 thereby shows the orientation of the individual elements—fuel cell 2 (or MEA) and bipolar plates 3—and their surfaces to each other for better understanding.

The fuel cell 2 can in particular be a so-called PEM fuel cell (with PEM=polymer electrolyte membrane). The fuel cell 2 comprises two gas diffusion electrodes 4 for this (one of them as an anode, the other one as a cathode) and an electrolyte 5 arranged therebetween, e.g. a polymer electrolyte membrane. One of the surfaces of the respective gas diffusion electrode 4 is thereby facing the electrolyte 5, e.g. the polymer electrolyte membrane, and the other surface one of the bipolar plates 3.

The bipolar plate is preferably formed of at least one plate or of two plates arranged plane-parallel to each other, wherein the plates are made of metal and are for example thin metal sheets, which enables a robust construction and a simple placement of the channel structure into the two plates. The two plates can in principle also be formed of carbon or a carbon material (carbon). These plates can nowadays be produced in a very thin-walled manner and have the advantage that they do not have to be coated.

In at least one outer side of the plate or one of the plates or both plates, channels K and webs S are made, e.g. by embossing (with mold and die), hydroforming (with mold and fluid), high speed forming (with mold and die), stretch forming, deep-drawing, extruding, or the like, or continuously by rolling or drawing. The bipolar plate 3 can thus be a formed part, which is e.g. formed of one or two thin metal sheets, which have elevations (=webs S) and recesses (=channels K), which form a flow field F with the channels K to the outer side, that is to the respectively associated membrane electrode arrangement.

During the operation of the fuel cell, the channels of the respective flow field are flown through by a fluid, e.g. an anode flow field by a fuel, e.g. hydrogen, and a cathode flow field by an oxidant, e.g. oxygen or air.

In FIG. 1 is only shown a part of the fuel cell arrangement 1—a fuel cell 2 with two bipolar plates 3 abutting on the outer sides—. In a manner not shown in more detail, further fuel cells 2, in particular their membrane electrode arrangement. In a manner not shown in detail, further fuel cells 2, not shown in detail abut the respective bipolar plate 3 on outer side, in particular their membrane electrode arrangement, in a plane-parallel manner.

Furthermore, at least one coolant channel and/or a dosing channel, not shown in detail, can be formed between two plates of a bipolar plate 3 by negative structures of the outer channel structures. Thereby, a plate functioning as anode and a plate functioning as cathode are thereby placed on top of each other on the channel base in such a manner that their side walls and webs form coolant channels and/or dosing channels lying on the interior.

In the following, different alternative embodiments of the invention are described by means of the FIGS. 2 to 4.

In order to avoid or to at least reduce transport losses, contact and/or material resistances and fluid or gas, heat transport and/or load transport, the channels K and the webs S respectively have an associated varying channel width b1 or web width b2 and/or a varying channel distance a. According to the invention, the channel width b1, the web width b2 and/or the channel distance are formed varying in such a manner that they are adapted to local requirements regarding the gas, heat and load transport.

The channel distance is thereby in particular meant to be the distance between a channel wall of a channel and the same channel wall of a channel arranged adjacent to this channel. The channel distance a thus corresponds to the sum of channel width b1 of a channel K and the web width b2 of an abutting web S.

FIG. 2 schematically shows a possible first embodiment for a channel structure on one of the outer sides of one of the plates of a bipolar plate 3.

The channels K and the webs S are hereby formed in such a manner that the webs S have a constant web width b2 along a flow direction R. The channel width b1 of the channels K however varies in such a manner that the channel width b1 increases in the flow direction.

Furthermore, the channel distance also increases corresponding to the increase of the channel width b1,

All channels K conveniently start from a common fluid inlet E and enter a common fluid outlet A. Depending on the associated flow field F, anode flow field or cathode flow field, a fuel, e.g. hydrogen is supplied via the fluid inlet E, or an oxidant, e.g. oxygen or air.

Alternatively, several fluid inlets E and fluid outlets A can also be provided.

FIG. 3 schematically shows a further alternative embodiment for a channel structure on one of the outer sides of a bipolar plate 3.

In this embodiment, the web width b2 varies with a constant channel width b1. Resulting therefrom, the channel distance a also varies. The web width b2 preferably decreases seen in the flow direction R. The channel distance a thus also decreases in the flow direction R.

FIG. 4 schematically shows a further alternative embodiment for a channel structure on one of the outer sides of one of the plates of a bipolar plate 3.

The web width b1 and the channel width b2 vary in this embodiment. Resulting therefrom, the channel distance a varies also or remains constant.

In other words: depending on requirements, the channel width b1 can thereby increase in the flow direction R corresponding in such a manner to the decrease of the web width b2, that the channel distance a remains constant. Alternatively, the channel width b1 can increase stronger than the web width b2 decreases, or vice versa, or can vary differently in an arbitrary manner, so that the channel distance a is not constant over the entire length of the flow field F, but varies, in particular increases or decreases.

Furthermore the channel widths b1 and the web widths b2 are formed oriented to each other and correspondingly, so that the channels K and the webs S are aligned smaller or wider to the fluid inlet E and vice versa to the fluid outlet A. In the example according to FIG. 4, the channels K are smaller and the webs S are wider at the fluid inlet E and the channels K are wider and the webs S are smaller at the fluid outlet A.

Depending on requirements, the channel width b1 of the channels K and the web width b2 of the webs S can for example increase or decrease at least by one half of the respective width b1 or b2 and thus one and a half or at the most the fourfold. The channel widths are thereby preferably in the region of 0.4 to 2.0 mm. The web widths are preferably in the region of 0.3 to 3.0 mm. Preferred relations between channel widths and web widths are in the following region: channel width=0.8 to 1.2 mm to web width=0.5 to 1.0 mm.

It is further ensured that the total height and thus the thickness of the bipolar plate 3 remains the same when varying the channel and/or the web contours and/or dimensions.
Daimler AG Dr. Mohr 07.11.2008

### LIST OF REFERENCE NUMERALS

1 Fuel cell arrangement
2 Fuel cell
3 Bipolar plate
4 Gas diffusion electrode
5 Polymer electrolyte membrane
a channel distance
b1 channel width
b2 web width
F Flow field
K Channels
R Flow direction
S Webs

1. A bipolar plate (3) for a fuel cell arrangement (1), adapted for placement between two adjacent membrane electrode arrangements, with at least one plate, and, in the case of more than one plate, at least two plates disposed plane-parallel relative to one another, wherein a flow field (F) is formed from channel structures made in the respective plate on one or both major surfaces, respectively, said channel structures comprising a plurality of channels (K) running between a fluid inlet (E) and a fluid outlet (A) and a plurality of bars (S) running between adjacent channels (K), wherein the channels (K) and/or the bars (S) provided on at least one of the major surfaces exhibit a varying channel width (b1), a varying web width (b2) and/or a varying channel spacing (a) along a flow direction (R) of a fluid between the fluid inlet (E) and the fluid outlet (A).

2. The bipolar plate (3) according to claim 1, wherein the channels (K) have an increasing channel width (b1) along the flow direction (R).

3. The bipolar plate (3) according to claim 1, wherein the bars (S) have a decreasing bar width (b2) along the flow direction (R).

4. The bipolar plate (3) according to claim 1, wherein the channel spacing (a) increases between two channels (K) arranged adjacent to each other along the flow direction (R).

5. The bipolar plate (32) according to claim 1, wherein the channels (K) are formed smaller and the bars (S) wider and the channel spacing (a) smaller at the fluid inlet (E) than at the fluid outlet (A).

6. The bipolar plate (10) according to claim 1, wherein the bar width (b1) increases along the flow direction (R) from the fluid inlet (E) to the fluid outlet (A) with a constant web width (b2).

7. The bipolar plate (10) according to claim 1, wherein the bar width (b2) increases along the flow direction (R) from the fluid inlet (E) to the fluid outlet (A) with a constant channel width.

8. The bipolar plate (10) according to claim 1, wherein all channels (K) start from a common fluid inlet (E).

9. The bipolar plate (10) according to claim 1, wherein all channels (K) enter a common fluid outlet (A).

10. The bipolar (10) according to claim 1, wherein the plates are made of metal.

11. A fuel cell arrangement (1) with several stacked fuel cells (2), wherein each fuel cell is formed as a membrane electrode arrangement with an electrolyte membrane (5) arranged between two gas diffusion electrodes (4), wherein a bipolar plate (3) is arranged between adjacent fuel cells (2), wherein on a major surface of at least one bipolar plate a flow field (F) is formed from channel structures made in the respective plate, said channel structures comprising a plurality of channels (K) running between a fluid inlet (E) and a fluid outlet (A) and a plurality of bars (S) running between adjacent channels (K), wherein the channels (K) and/or the bars (S) exhibit a varying channel width (b1), a varying web width (b2) and/or a varying channel spacing (a) along a flow direction (R) of a fluid between the fluid inlet (E) and the fluid outlet (A).

12. The fuel cell arrangement (1) according to claim 11, wherein the gas diffusion electrodes (4) are formed of a flexible layer.

13. (canceled)
